(19) United States
(12) Patent Application Publication
(10) Pub. No.: US 2017/0282415 A1
(43) Pub. Date: Oct. 5, 2017

(54) ROTATIONAL MOLDING SYSTEM

(71) Applicant: Ripple Engineering LLC, Kansas City, MO (US)

(72) Inventors: Martin Benedict Ismert, Prairie Village, KS (US); Ralph Lee Dohle, Plattsburg, MO (US)

(21) Appl. No.: 15/458,805

(22) Filed: Mar. 14, 2017

Related U.S. Application Data
(60) Provisional application No. 62/308,110, filed on Mar. 14, 2016.

(51) Int. Cl. B29C 41/04; B29C 41/38; B29C 41/52; B29C 41/46

(52) U.S. Cl. CPC B29C 41/04; B29C 41/46; B29C 41/38; B29C 41/52

(57) ABSTRACT

The rotational molding system comprising an internal air cooling system disposed on the mold and configured for one or more of selectively controlling air flow into or out of a cavity of the mold for actively cooling an interior surface of a part, pressurizing the cavity of the mold, allowing pressure equalization, or venting of off-gases. A first thermocouple and a second thermocouple disposed within the cavity to measure a temperature at the exterior surface of a part and the mold cavity. A control system in electronic communication with both said first thermocouple and said second thermocouple, may selectively operate the internal air cooling system to maintain the temperature of the cavity and the part's outside surface substantially the same. The mold and/or the oven containing the mold may be disposed for rotation about a first axis and a second axis during the rotational molding process.

### CROSS-REFERENCE TO RELATED APPLICATIONS

This Application claims priority to U.S. Provisional Patent Application No. 62/308,110, filed Mar. 14, 2016, to Martin Benedict Ismert and Ralph Lee Dohle, currently pending, the entire disclosure of which is incorporated herein by reference.

### BACKGROUND

Rotational molding (rotomolding) has for the most part been unchanged over the recent decades. Current rotational molding methods suffer from at least the following observable shortcomings. Current rotational molding methods are inefficient from a per-part production time perspective. Next, current rotational molding methods are inefficient from an energy consumption perspective. In addition, current rotational molding methods are vulnerable to manufacturing defects which render formed parts unusable. Further, there is a need in the art to regulate temperatures and pressures inside the mold to improve part quality, consistency, and user safety.

The current rotational molding methods are inefficient from a production time perspective. Traditionally, the process to mold large, hollow plastic parts through rotational molding includes utilizing a metal mold that is comprised of two half molds. An operator fills the mold with a powdered resin material, including a material like a polyethylene resin. Those two mold halves would be mounted to an arm that rotates to move the mold into various production stations, including a heating station, which is typically a large gas-fired oven. A known amount of powdered resin material is introduced into the mold to correspond to the size of the part and wall thickness of the finished part. The weight of this known amount of powdered resin is called the “shot weight.”

One rotational molding machine may include a plurality of arms, and each arm may include a mold for a different product, wherein the molds on the plurality of arms for a production cycle can be referred to as a production group. The current systems then calculate a “heat-time” which controls how long the mold of a known size is heated in order to melt and ensure dispersion of the entire amount of powdered resin. The production time will be governed by the heat-time for the largest shot weight in the product group. Thus, even if a smaller part is in a production group, its production time will be as long as the largest mold or shot weight in the product group. This creates production time inefficiencies simply due to manufacturing multiple types of parts in one production group.

In addition, in current configurations, the cooling cycle takes longer than the heating cycle. This is due to the temperature difference between the oven (550 degrees F.) and the cooling air blown upon on the exterior of the mold (typically room temperature). Thus, there is a need in the art for achieving additional efficiency in overall part production time by reducing the cooling time of each part.

Current rotational molding methods are inefficient from an energy consumption perspective. The current rotational molding systems often end up heating a portion of a large metal arm that supports the mold. Heating the metal arm increases the amount of energy needed to heat up the mold and the resin. Thus, the existing process tends to waste energy. In addition, current ovens have a large mass, which must be heated as well which takes additional energy. Thus, there is a need in the art to make the rotational molding process more energy efficient.

Current rotational molding methods are vulnerable to manufacturing defects which render formed parts unusable. Because the current molding process is time-based, molders tend to overcook or undercook parts, and each overcooking and undercooking have a negative effect on the quality of the molded item. Overcooking can lead to brittle parts, undercooking can lead to weaker parts or uncured (powdered) resin inside the part. Another shortcoming in the current rotational molding system is warpage of the outer surface of the part due to the mold and the part being cooled is by blowing air on the outside of the mold. As the surface of the mold begins to cool, the outer surface of the part (closest to the mold) cools first, shrinks, and tends to warp and move off the inside surface of the mold.

Another challenge with the current methods for rotational molding is maintaining atmospheric pressures inside the mold during the heating and cooling cycles. During the heating cycle, pressure is created by the expansion of the air inside the mold as well as the off-gassing of the powdered resin as it melts against the inside surface of the mold. This pressure tries to escape through the hot molten wall of the part to the outside of the mold through parting lines or inserts. This can cause blow holes, thin spots or voids in the part leading to poor quality or parts rejected as being out of specification. During the cooling cycle, as the air inside the part cools, a vacuum can form, possibly deforming the part or pulling air bubbles at areas of the plastic part that are still molten. To avoid this, the most common venting method is for one to make a hole in a mold and insert a static vent tube so that the pressure on the interior and exterior of the mold is equalized. An operator may fill this vent tube with a filter (typically steel wool) so that the powdered resin does not escape during rotation of the mold during heating. The challenge with this method is that during the heating stage, some powdered resin can cover the filter material and melt to it, reducing or eliminating the path for pressure to equalize. If the pressure can't equalize, then manufacturing defects may still occur.

Thus, there is a need in the art of rotational molding to reduce the time it takes to make each part, make the process more energy efficient, and improve part quality and consistency.

### SUMMARY

A rotational molding system comprising a mold for molding a part. The mold has a cavity corresponding to a shape of the part. The mold may include one embodiment of an internal cooling system of the present invention that includes a first vent configured for one of selectively introducing an air flow into the cavity, or selectively allowing air to flow out of the cavity. The rotational molding system may also include a second vent to selectively open to allow an air flow out of the cavity, when the first vent is configured to introduce an air flow from an air supply into the cavity. There may also be a single dual-flow vent that provides both a supply of air into the cavity and also provides a passage for air to exhaust out of the cavity. The dual flow vent may be used with a series of valves to control the amount of air flowing into and out of the cavity.

The present rotational molding system may also include a first thermocouple disposed within the mold to measure a temperature of an outside surface of a part molded in the mold, and a second thermocouple disposed within the mold to measure an atmospheric temperature of the cavity of the mold. The rotational molding system may include a control system in electronic communication with both the first thermocouple and the second thermocouple.

The present rotational molding system may include an internal air cooling system comprising the first vent and the second vent and the control system may be in operable communication with the air supply. The control system may operate the internal air cooling system to keep the atmospheric temperature of the cavity substantially the same as the temperature of an outside surface of the part based upon the measured temperatures of the first thermocouple and the second thermocouple.

The rotational molding system may further include the vent and the air supply comprising an internal pressurization system for introducing a positive pressure into the cavity by introducing air from the air supply through the vent into the cavity. This allows the molded part to be pressed against the mold to keep the outer surface of the part against the mold wall and, thereby, shortening the cooling time by keeping the part walls against the mold walls as the mold wall are cooled.

One embodiment of the vent of the present rotational molding system may be a component of an internal pressure equalization system disposed within a mold for allowing off-gases to escape the cavity while heating the resin and for equalizing the pressure in the cavity during the heating step. This feature simplifies the rotational molding process and removes operator interaction and error with the venting system if one designed a vent that could automatically open and close during the entire heating and cooling process to allow pressure to equalize in the cavity. This feature may also improve part quality and molding consistency.

In one embodiment, the rotational molding system may include an oven including an outer enclosure disposed for rotation about a first axis, a mold disposed within the outer enclosure of the oven, wherein the mold (and in one embodiment both the mold and the oven) may be disposed for rotation about a second axis, and wherein the first and the second axes are substantially orthogonal. This embodiment of the rotational molding system may also include the internal air cooling system described above.

The present invention also includes a method for rotational molding a part, the method comprising one or more of the steps of heating a mold and a resin inside the mold until a first thermocouple measures a predetermined first temperature; introducing cooling air into the interior of the mold upon the first thermocouple measuring the predetermined first temperature; and rotating the mold about a first axis and a second axis during both the heating step and the introducing cooling air step, wherein the first axis and the second axis are substantially orthogonal.

The present method may further include one or more of the steps of stopping the heating step, blowing cooling air around an exterior surface of the mold, blowing cooling air into a cavity of the mold, monitoring a temperature of an outer surface of a part and the temperature of the cavity and controlling the air flow around the outside of the mold and/or the air flow in the cavity to cool the outer surface of the part and the cavity of the mold at substantially the same rate.

The present method may also include one or more of the steps of introducing positive pressure in the cavity to push the exterior surface of the part against a wall of the mold after the heating step, and opening an exhaust vent during the heating step to equalize the pressure in the cavity or allow the evacuation of off-gases due to the heating step.

Other aspects and advantages of the present invention will be apparent from the following detailed description of the preferred embodiments and the accompanying drawing figures.

### BRIEF DESCRIPTION OF THE SEVERAL VIEWS OF THE DRAWING

The accompanying drawings form a part of the specification and are to be read in conjunction therewith, in which like reference numerals are employed to indicate like or similar parts in the various views, and wherein:

FIG. 1 is a perspective view of one embodiment of the interior mold cooling system of a rotational molding system in accordance with the teachings of the present invention;

FIG. 2 is a bottom view of one embodiment of a mold including one embodiment of an interior mold cooling system of a rotational molding system in accordance with the teachings of the present invention;

FIG. 3 is a section view of one embodiment of an air inlet or exhaust of the interior mold cooling system of FIG. 1 cut along the line 3-3 in an open position;

FIG. 4 is a section view of another embodiment of an air inlet or exhaust of the interior mold cooling system of FIG. 1 cut along the line 3-3 in an open position;

FIG. 5 is a section view of one embodiment of dual-air inlet and exhaust of the interior mold cooling system in accordance with the teachings of the present invention shown in a closed position;

FIG. 6 is a section view of the embodiment of dual-air inlet and exhaust of FIG. 5 shown in an open position;

FIG. 7 is a front right perspective view of one embodiment of an oven of a rotational molding system in accordance with the teachings of the present invention;

FIG. 8 is a front left perspective view of the oven of FIG. 7;

FIG. 9 is a back perspective view of the oven of FIG. 7;

FIG. 10 is a side view of one embodiment of an oven support to support an oven of a rotational molding system in accordance with the teachings of the present invention;

FIG. 11 is a top view of one embodiment of an oven support to support an oven of a rotational molding system in accordance with the teachings of the present invention;

FIG. 12 is a side view of one embodiment of the oven support of FIG. 11;

FIG. 13 is a front view of one embodiment of an oven support to support an oven of a rotational molding system in accordance with the teachings of the present invention;

FIG. 14 is a schematic view of one embodiment of the interior mold cooling system of a rotational molding system in accordance with the teachings of the present invention;

FIG. 15 is a sectional view of one embodiment of a mold including a part after using the rotational molding system of FIG. 11 cut along the line 15-15.

### DETAILED DESCRIPTION

The following detailed description of the present invention references the accompanying drawing figures that illustrate specific embodiments in which the invention can be practiced. The embodiments are intended to describe aspects of the present invention in sufficient detail to enable those skilled in the art to practice the invention. Other embodiments can be utilized and changes can be made without departing from the spirit and scope of the present invention. The present invention is defined by the appended claims and, therefore, the description is not to be taken in a limiting sense and shall not limit the scope of equivalents to which such claims are entitled.

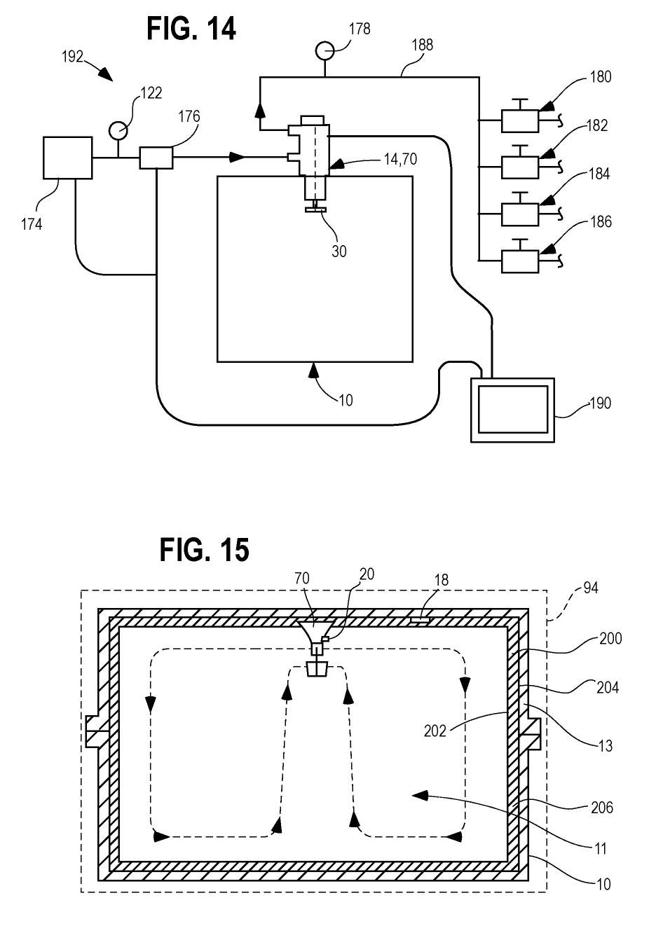

As such an improved rotational molding system 1 including an internal cooling system 192 (see FIG. 14) helps overcome these inherent inefficiencies. The present invention includes implementing an internal cooling system on the inside of the mold that allows for controlled cooling of the inside surface of the molded part while the outside of the mold is cooled to reduce any warpage, increase part quality, and decrease the cooling time (and thus, the per-part production time). An embodiment of the internal cooling system may introduce a controlled amount of airflow in the cavity of the mold at a predetermined temperature while monitoring the skin and cavity temperatures. The introduced controlled airflow into the cavity of the mold cools the part and mold from the inside. Thus, the cooling of the mold and the part can be carried out at a substantially identical and controlled rate, thereby reducing cycle time and reducing the surface warpage on the exterior and interior surface of the mold parts.

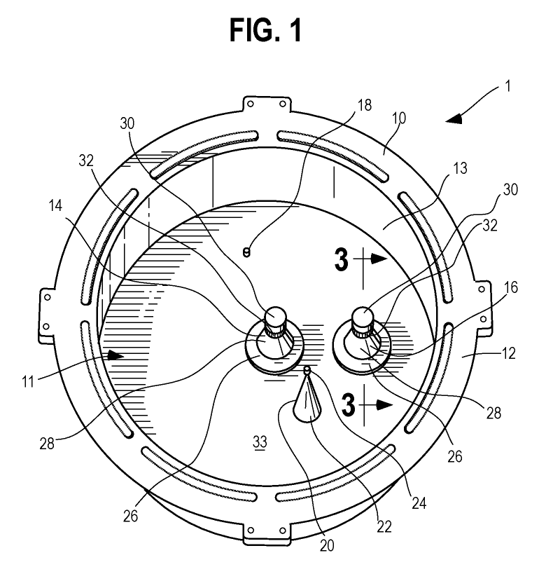

As shown in FIG. 1, rotational molding system 1 includes a mold 10 defining a mold cavity 11 and having a mold part 12 may include one or more mold wall 13 that defines a portion of the mold cavity 11. Mold 10 could be a newly constructed mold or could be an existing mold that is retro-fitted to include the elements of the rotational molding system 1 described herein. Mold 10 may include a cooling air inlet vent 14, a cooling air outlet vent 16, a skin thermocouple sensor 18, and a cavity thermocouple 20. The cavity thermocouple 20 extends into the mold cavity to measure the temperature in the cavity of mold 10. Thermocouple 20 has an insulated base 22 which does not heat up so it is not coated with melted resin during the rotational molding process. Thermocouple 20 includes a sensor 24 disposed a distance away from an inner surface 202 (see FIG. 15) of mold 10. As shown in FIG. 1, each vent, inlet vent 14 and outlet vent 16, is mounted on mold 10 using a mounting plate 26 and each vent 14, 16 includes an insulated base 28, a poppet 30, a seal 32 between the insulated base 28 and poppet 30.

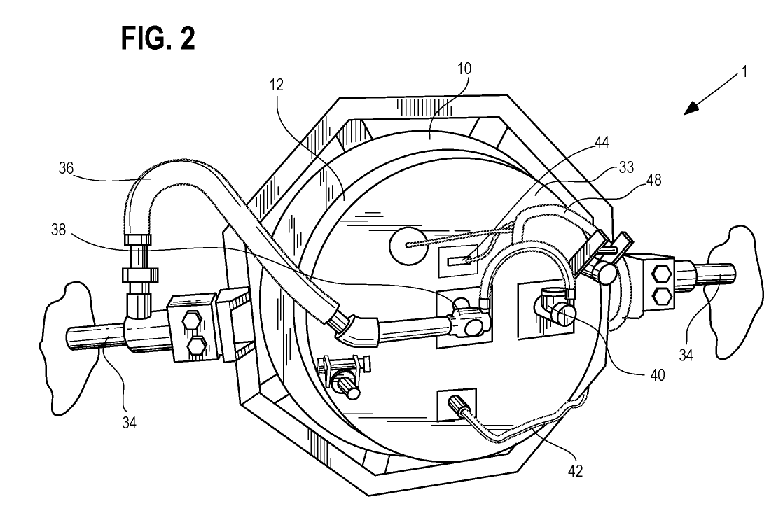

As shown in FIG. 2, the bottom 33 of mold 10 shows a B-Axis shaft 34 for rotating mold 10 thereon. FIG. 2 also illustrates a cooling air feed line 36 that supplies an inlet backside 38 and inlet vent 14 (see FIG. 1), and an exhaust backside 40 showing the outlet of the outlet vent 16. A skin thermocouple wire 42 for placing thermocouple 18 in electronic communication with a control panel or system, and a cavity thermocouple wire 44 for placing thermocouple 20 in electronic communication with a control panel or system may also be included as shown.

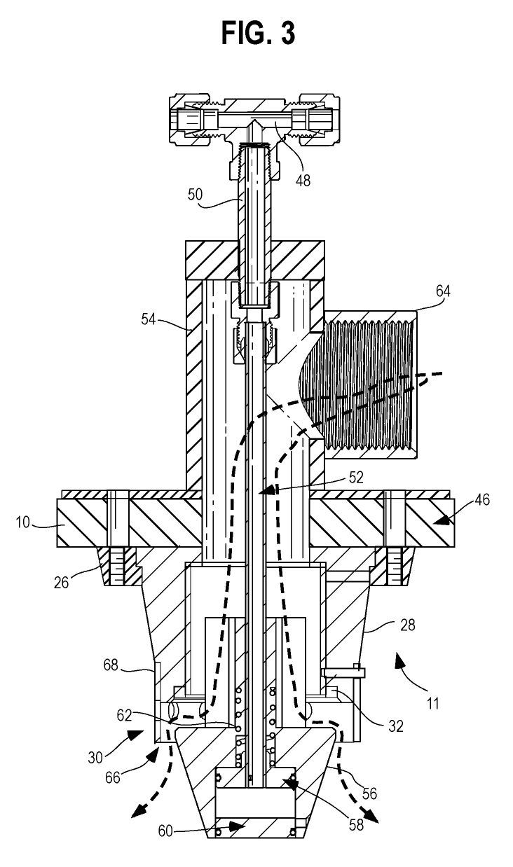

As shown in FIG. 3, air inlet vent 14 and air exhaust vent 16 are connected on either side of a mold plate 46 of mold 10. Vents 14 and 16 comprise a compressed air inlet feed tubing 48, a pipe nipple 50, an air tube 52, a supply/exhaust pipe 54, poppet 30 including a poppet head 56, a piston 58, a cylinder cap 60, a return spring 62, a coupling (threaded pipe) 64, an air in/out opening 66, and a diverter ring 68. Poppet 30 includes poppet head 56, piston 58, cylinder cap 60, return spring 62 and diverter ring 68. The compressed air actuates the poppet head 56 in order to allow air to enter or exit the cavity 11 through opening 66. The compressed air enters through the inlet feed tubing 48 through a T-section or an elbow and travels through pipe nipple 50 and air tube 52 and through piston 58 (which is static) so that compressed air blows against the cylinder cap 60 creating pressure to overcome the spring force of return spring 62 to move the poppet head 56 downward away from seal 32 to open up opening 66. At this point, air may be blown into cavity 11 of mold 10. In some cases a diverter ring 68 helps divert the flow of air from radially outward to more downward. The diverter ring 68 controls the direction of the air as it moves out of the poppet 30. Diverter ring 68 could also be used to block air from going in certain directions or create multiple outlets. Holes in the diverter ring can create both a radially outward and a downward air flow. Diverter ring 68 may be used to create any desired airflow pattern, either to make cooling more efficient or to avoid esthetic problems with the final molded part. This air flow diversion helps prevent a direct airflow against a malleable interior surface of a part formed in the mold, to prevent some warpage or rippling of the interior surface of the part. Upon release of compressed air, the return spring 62 will close the poppet head 56 against seal 32.

In another embodiment, poppet head 56 may be raised or lowered using a servo motor or any sort of other mechanical method, particularly when used with a jacketed mold (described below) so that you can put that component outside that jacket so the poppet motor stays at or near room temp while the mold is being heated.

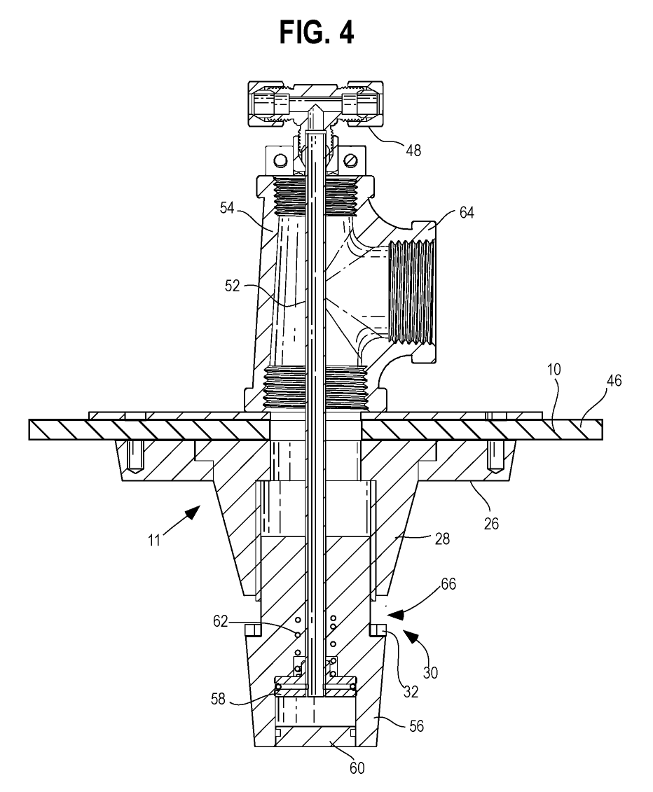

As shown in FIG. 4, another embodiment is shown that is a slight derivation of the vent of FIG. 3. In FIG. 4, the feed tubing 48 is connected directly to the supply/exhaust pipe 52 and no diverter ring is present. This configuration provides a more direct radial flow of air out of the air opening 66.

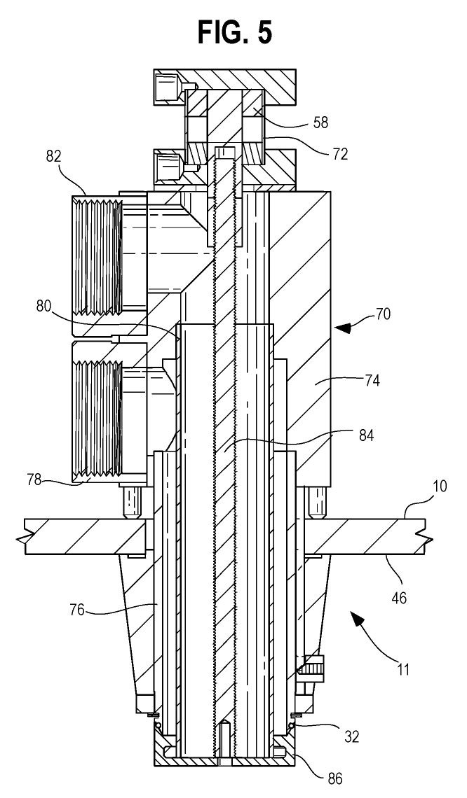

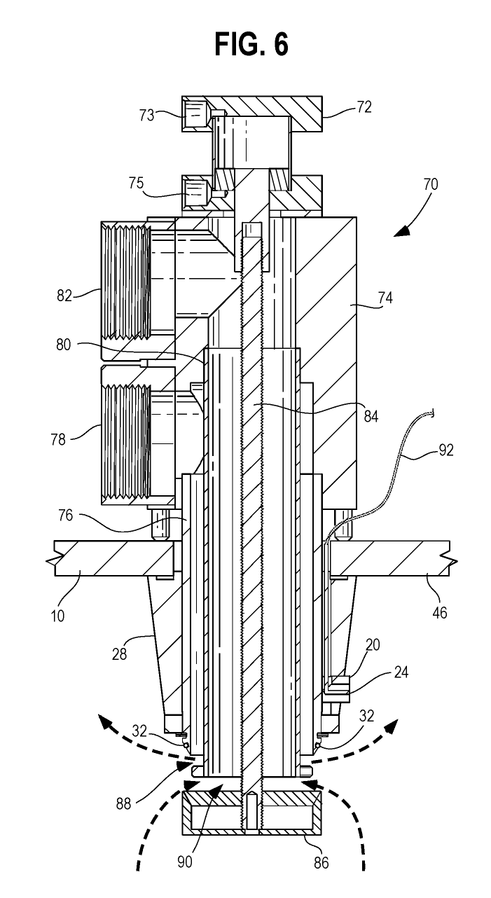

In another embodiment shown in FIGS. 5 and 6, vents 14 and 16 may be replaced by a single dual-flow vent 70 that provides an air supply and an exhaust in a single opening in mold 10 and part 200. This is desirable so as to reduce the number of plugs that have to be performed in order to complete a part 200. Dual-flow vent 70 may include an actuator 72, an outer housing 74, a cooling air supply pipe 76, cooling air coupling 78, an exhaust pipe 80, an exhaust air coupling 82, a pushrod 84, a poppet head 86, an air inlet opening 88, an air exhaust opening 90, and a thermocouple wire 92. Cooling air supply pipe 76 may be disposed inside Outer housing 74 and exhaust pipe 80 may be disposed inside cooling air supply pipe 76. The diameters of cooling air supply pipe 76 and exhaust pipe 80 may be selected to provide an open cross-sectional area that provides the same air flow volume, or different flow volumes depending upon the desired function of the vent 70. Cool air coupling 78 is in fluid communication with an air supply, and exhaust air coupling 82 is in fluid communication with an air outlet inside or outside oven 94. Actuator 72 is disposed outside mold 10 and uses compressed air acting on a piston to extend or retract poppet head 86 using a pushrod 84 disposed between poppet head 86 and piston 58 using compressed air introduced into actuator 72 through inlets 73 and 75, which facilitate connection to a compressed air source.

As shown in FIG. 1, the inlet and outlet vents 14 and 16 are contained within mold 10 cavity 11. Thus, as shown in FIGS. 3 and 4, the actuating mechanism (piston 58 and movable poppet head 56), insulated base 28, and poppet 56 are all within the mold cavity 11. This configuration allows for retrofitting existing molds when using a mold from an existing oven or molding device. As shown in FIGS. 5 and 6, in one embodiment the actuator 72 may be located just outside mold 10.

Seal 32 (in FIGS. 3-6) keeps the cold powdery resin out of the venting system while the mold is heating up. The resin is a very fine powder that can penetrate openings and bog down moving parts of these poppets. Seal 32 may be silicone in this case, however now known or subsequently developed similar materials may be used. Insulated base 28 plays an important role in allowing the actuation of the poppet 30 of each vent. The insulated base insulates the poppet from the mold surface which prevents the metal poppet from heating up with the rest of the mold, wherein if the poppet is heated up with the rest of the mold, the resin would melt and coat the entire poppet during the bi-axis rotation and the resin would keep the poppet from opening for cooling. Thus, the insulated base 28 keeps that metal poppet 30 cool enough so that the melted resin does not adhere to it providing that poppet 30 can actuate and open up throughout the heating and cooling cycle.

Insulated base 28 being tapered also facilitates the removal of the part after the molding process. The taper may be frusto-conical in shape. Mounting plate 26 mounts the vent to the mold. There may be an undercut on insulated base 28 that receives a flange of the mounting plate and clamps the mounting plate 26 to mold 10. The skin thermocouple sensor 18 measures the temperature of the external skin of the molded part. Cavity thermocouple 20 measures the internal air temperature of the mold cavity and the interior of the parts during the molding process. As shown in FIGS. 1 and 6, a sensor 24 of thermocouple 20 may also be mounted on an insulated base 28 to keep the thermocouple sensor 24 from being coated with resin during the molding process.

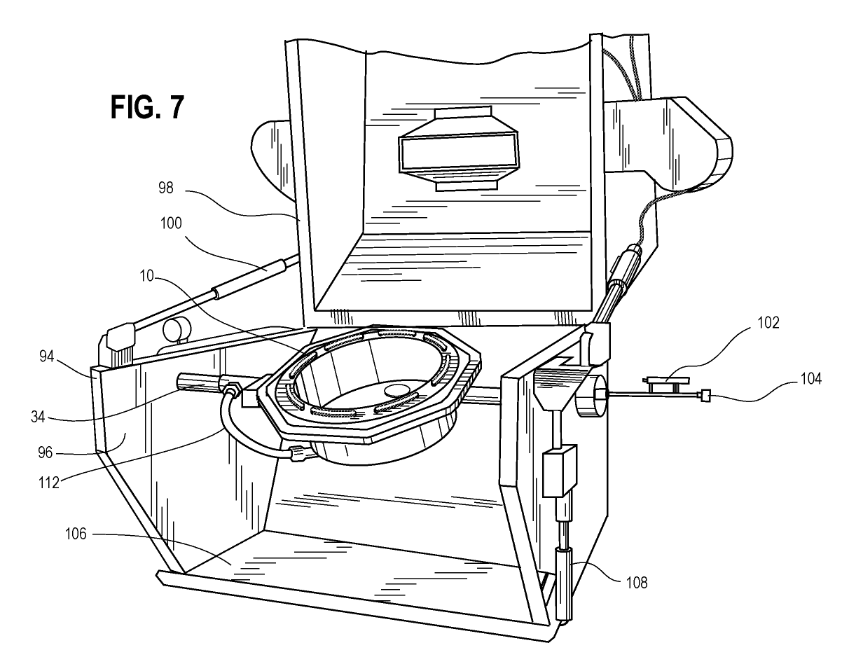

FIGS. 7-10 illustrate one embodiment of an oven 94 which can be used in the present rotational molding system 10. As shown in FIG. 7, oven 94 may include an oven body 96 and an oven lid 98 connected by a hinged connection so that lid 98 can be lifted relative to body 96 by a hydraulic cylinder 100 (or other pneumatic or mechanical lift device). Oven 94 may include a wireless temperature transmitter 102 that is in communication with the skin thermocouple wire 42 and cavity thermocouple wire 44 (see FIG. 2) so that the thermocouple measurements can be communicated to a control panel, device, or system. In addition, oven 94 may include a compressed air feed swivel 104 that allows the compressed air feed tubing 48 to rotate with mold 10. Oven 94 may also include a cooling vent door 106 that is moveable relative to oven body 96 using a cooling vent actuator 108. This opens an outlet for the cooling air to be blown on and around the outside of mold 10 during cooling of mold 10.

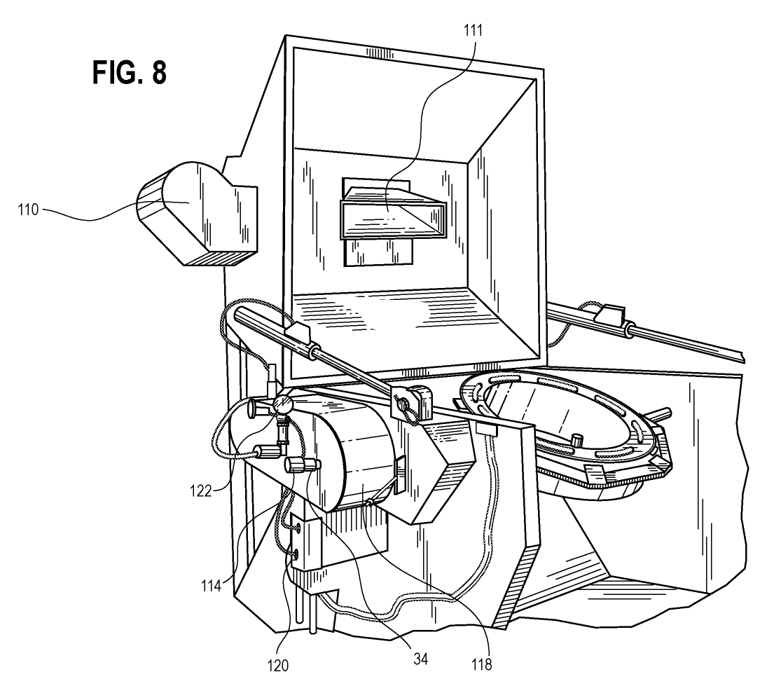

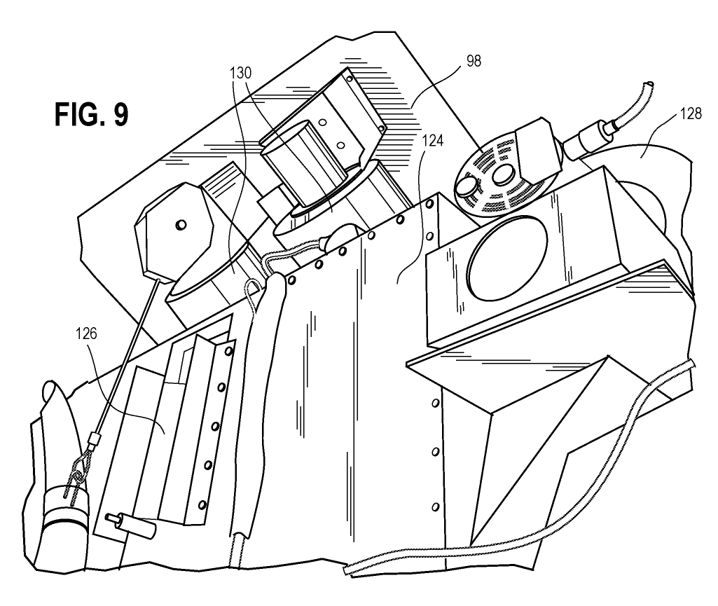

As shown in FIG. 8, oven 94 may include a hot air return fan 110 that circulates and recycles the hot-air through the heater during cooling. The hot air return fan 110 sucks hot air from the oven 94 during heating and then combines this air to the air fed into the heating element 124 (see FIG. 9) during the time mold 10 is being heated. Oven 94 may also include a cooling air supply pipe 112 that is connected to a cooling air swivel 114 and in fluid communication with a hollow portion of a B-axis axle 34 so that the B-axis shaft 34 can rotate mold 10 about the B-axis The B-axis shaft 34 may rotate three hundred sixty (360) degrees in both directions, but B-axis shaft 34 is a hollow shaft and in one embodiment is how the cooling air is supplied to mold 10 through a portion of a length of B-Axis shaft 34. B-Axis shaft 34 may be journaled for rotation on bearings and supported by the walls of the oven body 96. The B-axis shaft 34 may be driven by a B-axis drive 118. B-axis drive 118 may be a motor and a gear box with a sprocket operably connected to each of the motor and the B-Axis shaft 34. In one embodiment, a chain drive transmits rotation to B-axis shaft 34. However, any other drive mechanism is within the scope of the present invention. In addition, rotation of the B-axis shaft 34 may be slowed down, stopped or prevented using a B-axis brake assembly 120. B-axis brake assembly 120 may be used to stop the rotation of the B-axis shaft 34 when it's static, or in the operator fill position when an operator fills mold 10 with powdered resin or removes the part from the mold. Oven 94 may include a pressure gauge 122 to monitor the pressure of the cooling air being supplied into the cavity through inlet 14. In addition, as shown in FIG. 9, oven 94 may have a heater element housing 124 for covering heating element (not shown), a heater exhaust vent 126, and a heater blower 128. When mold 10 is being heated, air is blown over heater element using heater blower 128. In addition, hot air return fan 110 pulls air out of the oven cavity and recirculates the heated air over the heater element and back into the oven 94.

When it is time to cool the oven, the air ducts from hot air return fan 110 may be diverted so the hot air is sucked out of the oven and through heater exhaust vent 126. The cooling vent door 106 is lowered using cooling vent actuator 108 and two oven cooling blowers 130 pulling air from the outside atmosphere and blow it over mold 10 and out through the vent door 106.

In place of using oven 94 surrounding a mold 10, an embodiment (not shown) includes adding resistive heaters (not shown) directly to the outside of mold 10 to provide the necessary heat energy during the necessary heating time. The resistive heaters and mold 10 can be covered with an insulated jacket (not shown) thereby directing heat energy to mold 10 and not to the atmosphere. A cooling system may also be installed against the outer surface of the mold and covered by the insulated jacket. As mold 10 would be heated and cooled directly, the need for the large ovens and the extra energy to heat the surrounding air and the motive components is eliminated. That existing mold with the resistive heater and jacket can mount to one of the machines described below in the same fashion.

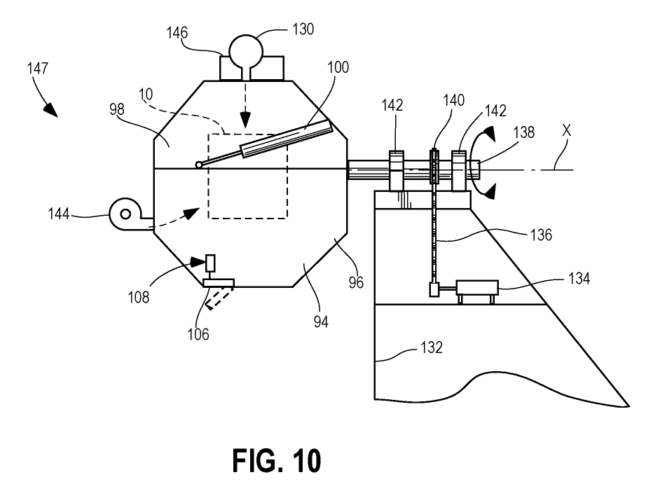

As shown in FIG. 10, in one embodiment, the oven 94 may be attached to an oven support device 147 that includes a stand 132 for rotation of oven 94 about the A-axis. A motor 134 is mounted on stand 132 and connected to an A-axis spindle 138 by a transmission (chain) 136. A sprocket 140 is coupled to the spindle 138 to engage the transmission (chain) 136 such that motor 134 can drive a rotation of spindle 138. A-axis spindle 138 is mounted in a substantially horizontal position on stand 132 with two bearings 142 to reduce the friction of rotating the entire oven 94 about the A-axis. As further shown in FIG. 10, oven 94 may include another cooling fan 144 disposed on either oven body 96 or oven lid 98. In addition oven 94 may also include a heater box 146 disposed on the top to heat the air in the oven 94.

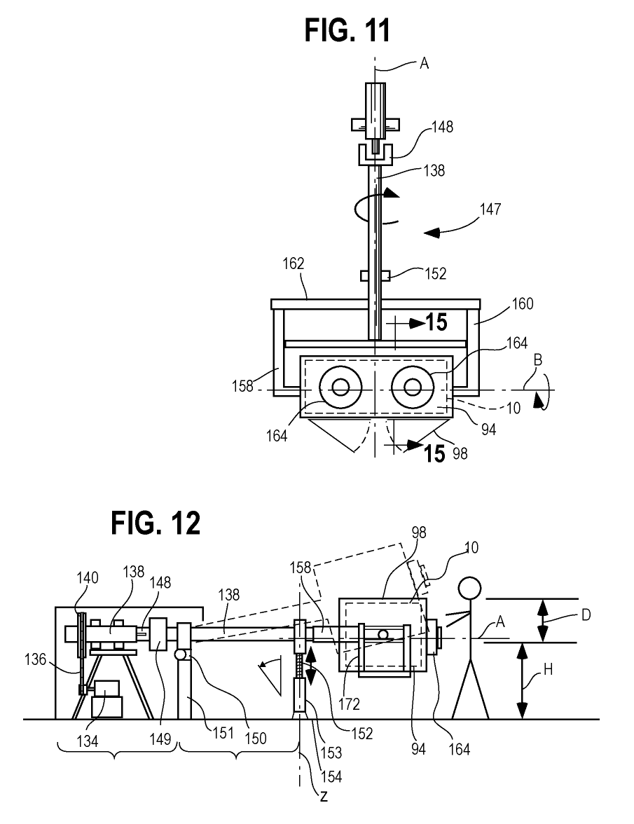

Another embodiment of an oven and oven support 147 of the rotational molding system 1 of the present invention is shown in FIGS. 11 and 12. Another embodiment of oven support 147 may further include a u-joint 148 which transfers a torque to A-axis spindle 138. Wires and hoses 149 may be connected to the motor and may be fed through a hollow passage in A-axis spindle 138 to remain hidden (see FIG. 12). The oven support may also include a hinge 150 connecting spindle 138 to a first support 151, and a vertical adjustment device 152 connecting spindle 138 to a second support 153. Vertical adjustment device 152 may be a screw drive or other known actuator like a hydraulic or pneumatic cylinder. As shown in FIG. 12, in one embodiment, the oven support 147 may position an oven 94 and mold 10 at a “home” position at a height “H” and the vertical adjustment device 152 moves the oven 94 and mold 10 upward a distance “D” to allow sufficient vertical clearance for the oven 94 and mold 10 to perform one or more complete rotations of up to at least ninety (90) degrees, but preferably a three-hundred sixty (360) degree full rotation.

First and second support may each incorporate bearing 142 to facilitate rotation of spindle 138 about the A-axis. Second support 153 may be connected to a support surface by a pivot joint 154 so that as the vertical adjustment device 152 raises and lowers the spindle 138, the vertical adjustment device 152 may pivot to remain substantially normal to spindle 138. Oven 94 may be mounted to spindle 138 by a support frame 156. As shown in FIG. 11, support frame may include a first leg 158, a second leg 160, and a back member 162, wherein first leg and second leg extend from back member 162 to form a “fork” for a connection for each end of oven 94. Oven 94 may be configured to rotate about the B-axis using a servo motor drive or other drive. In this embodiment, oven 94 may closely fit to mold 10 and mold 10 may be heated by one or more (preferably a plurality) of oven wall mounted heaters 164 that may have an adjustable wattage and may include an integrated blower for directing the heat toward mold 10. The integrated blower may be used without the heating element to blow atmospheric air against mold 10 during cooling. Thus, because there is not much air encapsulated in oven 94, the significant portion of the heat generated from the oven wall mounted heaters 164 is transferred directly to mold 10.

The oven 94 may have walls made of insulated panels. Oven 94 may be constructed for receiving molds 10 of similar size, yet having walls that are close to mold 10. This eliminates the need to buy heating elements and constructing an insulated jacket for each mold 10. This embodiment would be more economical if a manufacturer makes parts 200 from multiple molds 10 of similar size and mass. This embodiment of oven 94 may allow quick change-outs of existing molds within the oven so that a technician could switch from molding one part to the next part in only a few minutes.

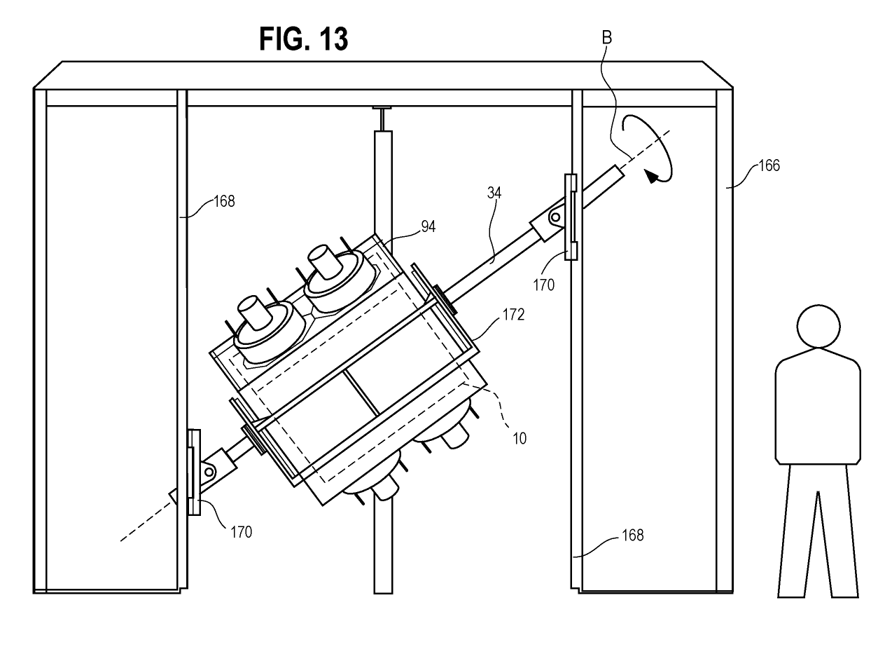

FIG. 13 illustrates yet another embodiment of the rotational molding machine for rotating mold 10 about an A-axis and a B-axis. As shown in FIG. 13, oven 94 and B-axis shaft 34 may be mounted on a frame 166 having a plurality of vertical rails 168. B-axis shaft 34 may be connected to a vertical rail using a pivot mount 170. Oven 94 may be connected to B-axis shaft 34 using a cradle frame 172 that receives the oven. The vertical position of pivot mount 170 on vertical rails 168 may be manually or automatically adjusted during the rotational molding process so as to provide a rotation of oven 94 and/or mold 10 about the A-axis. Oven 94, mold 10 and cradle 172 may also be rotated about the B-axis.

Now turning to FIG. 14, which illustrates a schematic view of one embodiment of the internal cooling system 192 and components of the present rotational molding system 1. The internal cooling system 192 of the rotational molding system 1 includes an air blower 174 for providing a supply of air to the vent, a first valve 176 for controlling the flow of air into the cooling vent. A pressure sensor 122 (see FIG. 8) for monitoring the pressure of the cooling air and another pressure sensor 178 for monitoring the pressure in the exhaust line. This allows a positive pressure to be maintained in the cavity 11 of mold 10. To control the pressure in the cavity 11 of mold 10, the internal cooling system 192 may include one or all of a second valve 180, a third valve 182, a fourth valve 184, and a fifth valve 186 that at least partially define an exhaust circuit 188. Exhaust circuit 188 can be adjusted to provide various amounts of exhaust volume for accommodating varied operating conditions of the present internal cooling system 192. As shown, actuator 72 of vent 14 and 16, exhaust circuit 188 and all valves 176, 180, 182, 184, and 186 may be in electronic communication with a control panel 190 (in addition to all thermocouples, movable doors or vents, conduits, and blowers). Valves 176, 180, 182, 184, and 186 may be solenoid valves.

A control panel 190 may also be part of the present rotational molding system 1, wherein the control panel 190 may do one or more of the following: receive input of the data including the shot weight, and physical properties of the mold, monitor the temperatures measured by any thermocouples in the system, measure the production time, monitor the temperature inside the mold, control the venting system, control the system as far as turning off the heating cycle, turning on pressure inside the mold, turning on the cooling cycle, controlling the flow of internal cooling air, and controlling the two axis rotation of the mold.

FIG. 15 shows a part that has been molded using the present rotational molding system 1. Part 200 results from the molding process wherein part 200 has an interior surface 202 and an exterior surface 204 contacting a wall 13 of mold 10. Interior surface 202 and exterior surface 204 define a wall 206 of part 200. Skin thermocouple 18 is disposed to measure a temperature of the exterior surface 204 of part 200. Cavity thermocouple 20 is disposed to measure the internal temperature of cavity 11 of mold 10 interior of the interior surface 202 of part 200. In addition, an oven 94 is sized so as to be close to the extents of mold 10. Vent 70 is disposed to circulate air (as shown) through cavity 11.

In operation, the rotational molding system 1 of the present invention is used to rotationally mold a part 200 in mold 10. Resin is added to the inside of mold 10, mold 10 is closed, oven lid 98 and body 96 are closed together, and the heating of the mold 10 is commenced. The present invention may utilize one mold 10 and an oven support 147 to make one part 200 at a time. A one-part-at-a-time machine optimizes the time required to produce that one part 200 and also may consistently result in a higher quality molded part 200. This one-at-a-time process significantly reduces scheduling complexity and allows an operator the time to service each mold appropriately without being rushed to service a mold on one arm while being pushed by the machine to complete the service because an opposite arm(s) is in the oven and must exit the oven so as to not overcook the parts in molds in the oven.

As the oven 94 is heated up, mold 10 is rotated on two axes (the A-axis and the B-axis), and as the resin melts, the melted resin sticks to the wall(s) 13 of mold 10. The A-axis is commonly referred to the “rock” direction and the B-axis is commonly referred to the “roll” direction. In one embodiment, oven 94 may be rotated in both the clockwise and counterclockwise direction about the A-axis, approximately sixty (60) degrees each direction. At the same time it is rotating or oscillating, mold 10 is also rotating about the B-axis in a rolling approximately seven hundred twenty (720) degrees in one direction and reversed for seven hundred twenty (720) degrees. Alternatively, mold 10 can rotate about the B-axis infinitely in either direction. In one embodiment, the speed of the rotation of the mold in both the A-axis and B-axis and the corresponding angle of rotation is controlled by a control panel, switch, or other control process and may be customized for the part being produced.

In one embodiment, one or more poppets 30 may be opened during the heating cycle (once or at designated intervals) to release off-gases that are created when the resin changes state from a solid to a liquid. It has been observed that these off-gases often cause pressure buildup inside mold 10. The pressure build up may result in blow holes (not shown) through the wall 206 of the part 200 at areas where air can escape such as the mold parting line and/or removable inserts. In many cases, these blow holes are aesthetic problems for finished parts or introduce points of leakage in parts that are used to hold liquids. Poppets 30 opening up can allow the build-up off-gases to escape, thus, eliminating the conditions which cause the blow holes. In addition, in an embodiment, this exhaust air from the inside of part 200 can be routed from the oven to an exhaust hood (not shown) and removed from the building as some resins can produce noxious gases during molding. This will protect the operators and those nearby the machine from the noxious gases. The position of poppet(s) 30 may be tracked by control system 190 and, thus, the opening and closing of poppets 30 during heating may be timed so that the poppets 30 are positioned at a higher position so that the liquid and/or powdered resin does not escape through a poppet 30 due to gravity.

In one embodiment, the vent assembly is used to pressurize the inside of the part at specific times during and/or at the end of the heating cycle. This pressurization may occur after the exterior cooling fans have been turned on but before the internal cooling air is turned on. In one embodiment, once a certain internal temperature has been reached, the temperature will continue to rise inside part 200 even after the heaters are turned off and the cooling fans are turned on due to heating momentum. The process monitors the internal air temperature of the cavity 11, in one embodiment, the continued increase in temperature due to heating momentum is used to the advantage of the present process. The cooling of the exterior of mold 10 can be started prior to turning on the internal cooling air.

When the outside of mold 10 begins to cool, the outer skin/exterior surface 204 of part 200 also begins to cool and shrink away from the mold wall 13, creating an air barrier which acts like an insulator, causing part 200 to cool slower. Thus, one or more vents 14, 70 can be opened, with the exhaust vent 16 being closed or one or more exhaust valves 180, 182, 184, 186 being closed. The blower 174 may be turned on to pressurize the inside of the part, inflating the cavity 11 enough so that the exterior surface 204 of part 200 touches the inside wall 13 of mold 10 again. Keeping the exterior surface 204 of part 200 against the mold wall 13 increases the cooling rate and reduces the cooling cycle time. Further, once the predetermined internal temperature setpoint has been reached, telling us the internal skin of the part has fully sintered, the vent 16 or one or more exhaust valves 180, 182, 184, 186 are opened to begin to flow cooling air inside the part 200, drastically reducing the temperature of the part 200 from the inside out and speeding cooling time. During this cooling process, inside surface 202 of part 200 can remain pressurized to keep the outer skin/exterior surface 204 against mold 10 by keeping a slight positive pressure inside cavity 11 and/or controlling the volume of air flowing in and the volume of air flowing out, further speeding cooling time.

An unexpected benefit in significantly reducing the time that the resin is exposed to high temperatures is that other engineered resins may be introduced to the rotomolding process. There are a number of known resins available for the injection molding process that may be used in rotomolding in the present rotational molding system due to the smaller amount of time that the resin is exposed to high heat. The availability of more materials may spur growth in the rotational molding industry due to the ability to mold structures and parts that were not possible using only basic polyethylene and polypropylene materials common in the art. Another additional benefit of reducing the cooling time may be effecting a change in the matrix of the polymer or the material, which may improve or otherwise affect strength, toughness, hardness, or other physical or performance property of the material. Now that cooling of the part can be controlled, the properties of the part may be optimized depending on the use of part 200.

At a specific predetermined temperature, in this embodiment of a temperature-based system of the present rotational molding system, the powdered resin should be melted and distributed on the outer wall of mold 10. In one embodiment, the heaters are turned off and the control panel switches immediately to cooling while the mold/oven assembly remains in the same position and continues to rotate bi-axially. The heaters are turned off and the poppet heads 56 of the present venting/cooling system 192 may be opened using compressed air. Both poppet heads 56 of vents 14 and 16 (or the single poppet head 86 of vent 70) may actuate and open up, and then the cooling air blower turns on.

There are a number of ways that cooling air can be introduced into cavity 11. The cooling air can come on full blast, or it can ramp up slowly so as not to disrupt the hot inside surface 202 of part 200, where the inside surface 202 could ripple due to the air stream or make it aesthetically unpleasing to the customer. So while there are fans blowing on the outside of mold 10 to cool the outside of mold 10, the cooling air is simultaneously coming in through vent 14 or 70 and circulating through the inside of the newly formed part and then exhausting out of the mold through vent 16 or, in the case of vent 70, the air enters and exits cavity 11 from the same vent 70.

In one embodiment, approximately between 100 to 200 cubic feet per minute (CFM) of cooling air flows through the interior of the part 200—inward through the inlet vent 14, around the interior of the part 200, out through the exhaust poppet 16, and then outward through an exhaust opening. The cooling air inlet vent 14 may also include a diverter ring 68 for directing the direction of the cooling air flow into mold 10. The more cooling air that can be brought through the inside of the molded part 200 the faster part 20 can be cooled. In some cases, the ratio of the cooling air CFM to part volume should be at least 15 to 1. There may be other methods that air can be introduced into cavity 11, such as a compressed air source. In addition, the air could be heated or cooled or otherwise conditioned prior to being introduced into cavity 11 of mold 10 if desired. In addition, a vacuum source or exhaust fan may be incorporated in the exhaust vent 16 or 90 to help move air out of cavity 11 depending on a number of variables, such as the size of part 200 and the distance between the inlet vent 14 and the outlet vent 16.

Thus, part 200 cools both from the outward surface 204 inward toward the center of wall 206 and from the inward surface 202 outward toward the center of wall 206, which reduces the time period for cooling the part 200. This also helps to eliminate warpage of the walls 206 of part 200 since both sides are cooled at the same time, versus only the outside of the part 200 being cooled with current technology.

The rotational system of the present invention can be monitored using control panel 190 such that the interior surface temperature of part 200 and the outside surface temperature of part 200 are reduced together at the same or substantially the same rate. The thermocouple 18 that is disposed on mold 10 to measure the surface temperature of part 200 may be paired with the thermocouple 20 to measure the internal air temperature of cavity 11, such as monitored and compared in the controller 190, so that an operator or the controller 190 can control the flow of air blown on the outside of mold 10 or provided into cavity 11 to optimize the cooling to prevent warpage from one surface/side of wall 206 of part 200 from cooling faster than the other based upon the comparison of the readings of the respective then thermocouples. After the cooling step, mold 10 is opened and the part is removed from mold 10.

In another embodiment, all listed improvements can act harmoniously as one system to significantly reduce the processing time and increase the quality of a rotomolded part using existing tooling. The process starts when an existing mold 10 is mounted inside an optimally small oven containing a heating and cooling system as described herein. As shown in FIGS. 11 and 12, oven 94 is fixed to one embodiment and machine 147 than rotates it about two orthogonal axes (an A-axis and a B-axis). This machine 147 provides the energy sources needed to heat and cool the mold from the outside, cool the mold from the inside, monitor multiple temperatures and monitor multiple pressures inside and outside the mold.

When the internal cooling system of FIG. 14 is used, once another internal temperature setpoint has been reached and measured by thermocouple 20, cooling air is introduced inside the part by turning on the blower 174, opening valve 176, opening the poppet 30 and opening the solenoid valve(s) 182, 184, 186, 188 on the exhaust circuit 188 of the vent. Cooling air flow can be controlled in two ways. The first is by controlling the speed of the blower 174 which changes pressure. This is done using a VFD (variable frequency drive) to operate the blower motor. The other way is by opening more than one valve 182, 184, 186, or 188 on the exhaust side of the vent circuit. For example, you may want to introduce air at a lower flow at the beginning of the cooling cycle so as not to disrupt the internal surface of the part as it is still very hot and molten. As the internal temperature is reduced, additional valves 182, 184, 186, 188 plumbed in parallel may be opened by the controller 190 to allow more air flow through the inside of the part. Each valve 182, 184, 186, 188 would have a pre-determined flow rate at certain pressures when open. Since the operator or the control panel can control exhaust valves 182, 184, 186, 188, the inside 202 and outside 204 of part 200 may be cooled at the same rate, or whatever rate is required to produce the desired part by knowing both the internal and external temperature of part 200 as measured by the thermocouples 18 and 20.

Once another predetermined temperature setpoint has been hit and measured by thermocouple 20, the machine may stop the cooling process and may bring the oven to a “home” position which allows the operator to access the mold and remove the part. The process is then repeated or the mold can be switched out with a different mold.

As is evident from the foregoing description, certain aspects of the present invention are not limited to the particular details of the examples illustrated herein. It is therefore contemplated that other modifications and applications using other similar or related features or techniques will occur to those skilled in the art. It is accordingly intended that all such modifications, variations, and other uses and applications which do not depart from the spirit and scope of the present invention are deemed to be covered by the present invention.

Other aspects, objects, and advantages of the present invention can be obtained from a study of the drawings, the disclosures, and the appended claims.

We claim:

1. A rotational molding system comprising:
a mold for molding a part, said mold having a cavity corresponding to a shape of the part,
a first vent configured for one of selectively introducing an air flow into the cavity, or selectively allowing air to flow out of the cavity.

2. The rotational molding system of claim 1 further comprising a second vent to selectively open to allow an air flow out of the cavity, and wherein the first vent is configured to introduce an air flow from an air supply into the cavity.

3. The rotational molding system of claim 1 further comprising a first thermocouple disposed within said mold to measure a temperature of an outside surface of a part molded in said mold, and a second thermocouple disposed within said mold to measure an atmospheric temperature of a cavity of said mold.

4. The rotational molding system of claim 3 further comprising a control system in electronic communication with both said first thermocouple and said second thermocouple.

5. The rotational molding system of claim 4 further comprising an internal air cooling system comprising the first vent and the second vent, wherein said control system is in operable communication with said air supply and said control system operates the internal air cooling system to keep said atmospheric temperature of said cavity substantially the same as the temperature of an outside surface of said part based upon the measured temperatures of said first thermocouple and said second thermocouple.

6. The rotational molding system of claim 1 further comprising a blown air supply, wherein said vent and said air supply comprises an internal pressurization system for introducing a positive pressure by introducing air from said air supply through said vent into said cavity.

7. A rotational molding system of claim 1 wherein said vent is a component of an internal pressure equalization system disposed within a mold for allowing off-gases to escape the cavity while heating the resin.

8. A rotational molding system comprising:
an oven including an outer enclosure, said outer enclosure disposed for rotation about a first axis,
a mold disposed within the outer enclosure, said mold disposed for rotation about a second axis; and
wherein the first and the second axes are substantially orthogonal.

9. The rotational molding system of claim 8 further comprising an internal air cooling system disposed on the mold and configured to introduce a continuous air flow through a cavity defined by said mold for actively cooling an interior surface of a part.

10. The rotational molding system of claim 9 further comprising a first thermocouple disposed within said mold to measure a temperature of an outside surface of said part molded in said mold, and a second thermocouple disposed within said cavity of said mold to measure an atmospheric temperature of a cavity of said mold.

11. The rotational molding system of claim 10 further comprising a control system in electronic communication with both said first thermocouple and said second thermocouple.

12. The rotational molding system of claim 11 wherein said control system operates the internal air cooling system to keep said atmospheric temperature of said cavity substantially the same as the temperature of an outside surface of said part.

13. A method of rotational molding a part, the method comprising the steps of:
heating a mold and a resin inside said mold until a first thermocouple measures a predetermined first temperature;
introducing cooling air into the interior of the mold upon the first thermocouple measuring the predetermined first temperature; and
rotating said mold about a first axis and a second axis during said heating step and said introducing cooling air step, wherein said first axis and said second axis are substantially orthogonal.
